(19) United States
(12) Patent Application Publication
(10) Pub. No.: US 2025/0335675 A1
(43) Pub. Date: Oct. 30, 2025

(54) INTEGRATED CIRCUIT DESIGN WITH PROTECTION BASED ON PROTECTED DECLARATION AND ANNOTATION

(71) Applicant: SiFive, Inc., Santa Clara, CA (US)

(72) Inventor: John Koenig, Berkeley, CA (US)

(73) Assignee: SiFive, Inc., Santa Clara, CA (US)

(21) Appl. No.: 18/646,193

(22) Filed: Apr. 25, 2024

(51) Int. Cl. G06F 30/32; G06F 119/02

(52) U.S. Cl. CPC G06F 30/32; G06F 2119/02

(57) ABSTRACT

The present application relates to generating a design for an integrated circuit. The integrated circuit can include state elements that store data and a protection component, such as an encoder or decoder, that enables detection and, possibly correction, of errors in the stored data. The integrated circuit can be designed using an integrated circuit generator that implements a hardware description language (HDL). In the HDL, code for the integrated circuit can be defined. This code can indicate that the data forms an atomic data group to be processed together and can declare this data as being protected by a particular protection type (e.g., error correction codes). An annotation referring to the data protection can be included in an operation defined in the code. Based on the declaration and the annotation in the code, a data structure can be generated and can indicate that the protection component is to be implemented.

### BACKGROUND

An integrated circuit generator can enable designing integrated circuits. In an example, the integrated circuit generator uses a hardware description language (HDL) and receives inputs describing aspects related to an integrated circuit. HDL-based code can be generated based on the inputs. A circuit design for the integrated circuit can be generated from the HDL-based code.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 illustrates an example of a system for facilitating generation and manufacture of integrated circuits in accordance with embodiments of the present disclosure.

FIG. 2 illustrates an example of computing components of a system for facilitating generation of integrated circuits in accordance with embodiments of the present disclosure.

FIG. 3 illustrates an example of components of an integrated circuit design service infrastructure in accordance with embodiments of the present disclosure.

FIG. 4 illustrates an example of an integrated circuit design that excludes protection in accordance with embodiments of the present disclosure.

FIG. 5 illustrates an example of an integrated circuit design that includes protection in accordance with embodiments of the present disclosure.

FIG. 6 illustrates an example of a flow for generating an integrated circuit design including protection in accordance with embodiments of the present disclosure.

FIG. 7 illustrates an example of a flow for correcting protection errors in an integrated circuit design in accordance with embodiments of the present disclosure.

FIG. 8 illustrates an example of a flow for updating an integrated circuit design including protection in accordance with embodiments of the present disclosure.

### DETAILED DESCRIPTION

Embodiments of the present disclosure relate to, among other things, generating a design for an integrated circuit that includes protection. The integrated circuit can include state elements that store data. As used herein, protection refers to using error protection such that the integrated circuit is more robust to events (e.g., gamma ray bursts, power interruption, etc.) that may result in errors in the data. The error protection can enable the detection and, possibly or optionally, correction of such errors.

In an example, the integrated circuit can be designed to store and process a data set. Per the design, the processing can be temporally and/or spatially distributed. For example, one subset of the data can be processed in a first processing cycle, whereas another subset of the data can be processed in a second processing cycle. Additionally, or alternatively, the two subsets can be processed by different processing components of the integrated circuit.

The design can be generated by using, at least in part, an integrated circuit generator that implements a hardware description language (HDL). HDL code can be generated and can include a declaration that a grouping of data is to be protected. The grouping can correspond to a subset of the data set, where all the data of the subset is to be processed temporally and/or spatially together. The grouping can be referred to as an atomic data group to connotate that the grouped data is to be processed together (e.g., temporally and/or spatially). The HDL code can also include a variable corresponding, fully or partially, to the atomic data group, in addition to an operation applied to the variable. Because the atomic data group is to be protected, the HDL code can also include an annotation for the variable in the syntax of the operation. The annotation indicates that the operation applies to protected data. Given the declaration and the annotation, the integrated circuit generator can output the design of the integrated circuit. The design indicates that a protection component (e.g., an encoder and/or a decoder) is included in the integrated circuit design. This protection component can be specific to the state element(s) that would store the atomic data group and/or to the processing component(s) that would implement the operation. In other words, the protection applies to the atomic data group rather than the entire data set, whereby the protection component's implementation is granular to the atomic data group level. By doing so, the proper circuit protection(s) can be implemented, while also improving the design (e.g., to reduce the power consumption of the integrate circuit by avoiding the need to protect the entire data set and by avoiding, any time an operation applies to a data subset, the need to decode and/or encode the full data set). These and other features of the present disclosure are further described herein below.

Automated generation of integrated circuit designs permits a configuration of an application specific integrated circuit (ASIC) or a system on a chip (SoC) to be specified in terms of design parameters (or colloquially knobs). A system may then automate the operation of commercial electronic design automation (EDA) tools for design of the integrated circuit using the design parameters.

For example, a system may execute an integrated circuit generator to access design parameters and generate an integrated circuit design. In an example, the integrated circuit generator may use a hardware description language (HDL) embedded in a general-purpose programming language (e.g., Scala) that supports object-oriented programming and/or functional programming. For example, Chisel, an open source HDL embedded in Scala, a statically typed general purpose programming language that supports both object-oriented programming and functional programming, may be used to generate an integrated circuit design. The integrated circuit generator may include module descriptions that specify input(s), output(s), and/or a description(s) of a functional operation of a module (e.g., a processor core, cache, or the like, which may be represented, for example, by a Scala class).

In a process referred to as elaboration, the integrated circuit generator may execute to generate an integrated circuit design based on the design parameters. The integrated circuit design may include instances of module descriptions with connections being made. For example, the integrated circuit generator may execute constructor code to establish instances of Scala classes, with wired connections between them, as an instantiation of an integrated circuit design. In an example, the integrated circuit design may be encoded in an intermediate representation (IR) data structure. The IR data structure may be configured for optimization and/or translation by a compiler to produce a register-transfer level (RTL) data structure. For example, the integrated circuit generator may generate the integrated circuit design as a flexible intermediate representation for register-transfer level (FIRRTL) data structure. The FIRRTL data structure may be compiled by a FIRRTL compiler to produce an RTL data structure.

In a process referred to as compilation, the elaborated integrated circuit design (e.g., the IR data structure) may be compiled to generate an RTL data structure. For example, compiling the integrated circuit design may comprise executing one or more lowering transformations (e.g., compiler transformations that remove high-level constructs) to transform the integrated circuit design to generate the RTL data structure. The RTL data structure may encode a topology of logic associated with the instances of module descriptions implemented in the integrated circuit design (e.g., logic descriptions of the modules, such as the processor cores, caches, and the like). The RTL data structure may be compatible with EDA tools that may be used for functional verification (e.g., simulation analysis), synthesis (e.g., conversion to a gate-level description), placement and routing (e.g., physical design), and/or manufacturing of an integrated circuit (e.g., a processor, a microcontroller, an ASIC, or an SoC). In an example, the RTL data structure may comprise Verilog. For example, the integrated circuit design may be compiled using a FIRRTL compiler to generate Verilog.

The integrated circuit generator and/or a compiler may use Scala or Chisel to generate an integrated circuit design including an object model in a standardized data structure (e.g., a java script object notation (JSON), metadata, etc. Through use of classes of Chisel or Scala, which can define properties (e.g., data members) and behaviors (e.g., methods) that objects of that class can possess, design codes can be reused through use of libraries that implement an abstract solution and be instantiated with many different data types.

Moreover, the integrated circuit generator and/or a compiler may use Scala or Chisel to generate an integrated circuit design instances of module descriptions. A module description may specify input(s), output(s), and/or a description(s) of a functional operation of a module (e.g., a processing component such as arithmetic logic units, multiplexers, and/or any other component that can belong to a processor core; a state element such as a register or any other component that can store data; a protection component, such as an encoder and/or decoder implementing a particular protection technique such as single error correction double error detection (SECDED) or parity bits-based protection; etc. all of which may be represented, for example, by a corresponding Scala class). Instances of module descriptions may include input(s) and/or output(s) (e.g., wires) that may be internal to the integrated circuit design (e.g., as opposed to a system level input(s) and/or output(s) that may be external to the integrated circuit design). The generator (e.g., Chisel) may use an HDL embedded in a general-purpose programming language (e.g., Scala) to generate the integrated circuit design. The integrated circuit design may be encoded in an IR data structure. A compiler (e.g., a FIRRTL compiler) may compile the IR data structure to produce an RTL data structure. The RTL data structure may encode logic descriptions associated with the instances of module descriptions implemented in the integrated circuit design (e.g., Verilog).

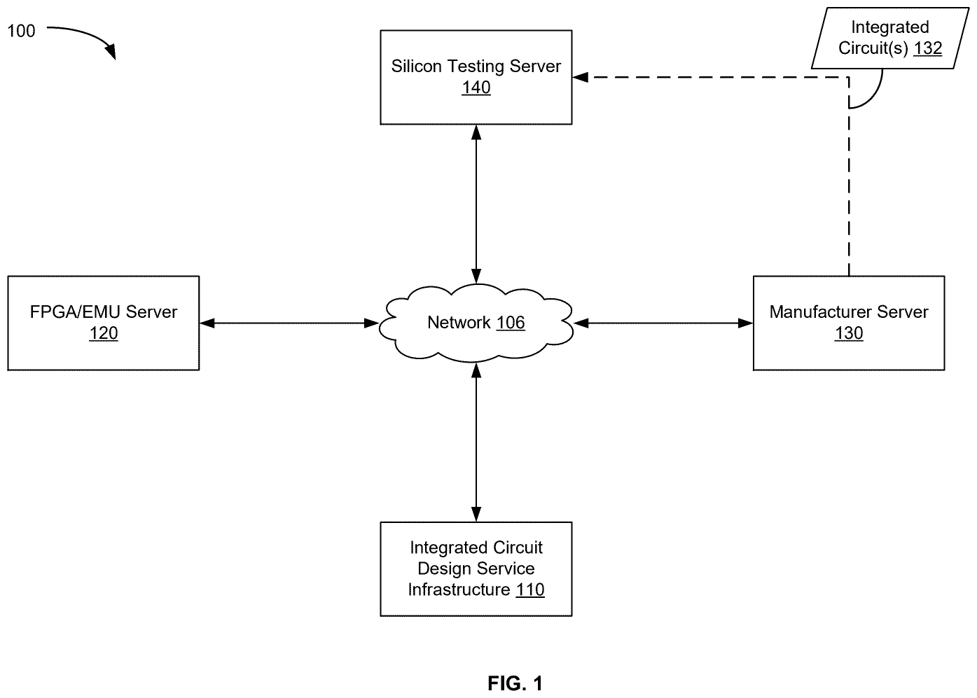

FIG. 1 illustrates an example of a system 100 for facilitating generation and manufacture of integrated circuits in accordance with embodiments of the present disclosure. The system 100 includes a network 106, an integrated circuit design service infrastructure 110 (e.g., integrated circuit generator), a field programmable gate array (FPGA)/emulator server 120, and a manufacturer server 130. For example, a user may utilize a web client or a scripting API client to command the integrated circuit design service infrastructure 110 to automatically generate an integrated circuit design based on a set of design parameter values selected by the user for one or more template integrated circuit designs. In an example, the integrated circuit design service infrastructure 110 may be configured to generate an integrated circuit design like the integrated circuit design shown in some of the next figures.

The integrated circuit design service infrastructure 110 may include a register-transfer level (RTL) service module configured to generate an RTL data structure for the integrated circuit based on a design parameters data structure. For example, the RTL service module may be implemented as Scala code. For example, the RTL service module may be implemented using Chisel. For example, the RTL service module may be implemented using flexible intermediate representation for register-transfer level (FIRRTL) and/or a FIRRTL compiler. For example, the RTL service module may enable a well-designed chip to be automatically developed from a high-level set of configuration settings using a mix of Diplomacy, Chisel, and FIRRTL. The RTL service module may take the design parameters data structure (e.g., JSON file) as input and output an RTL data structure (e.g., a Verilog file) for the chip.

In an example, the integrated circuit design service infrastructure 110 may invoke (e.g., via network communications over the network 106) testing of the resulting design that is performed by the FPGA/emulation server 120 that is running one or more FPGAs or other types of hardware or software emulators. For example, the integrated circuit design service infrastructure 110 may invoke a test using a field programmable gate array, programmed based on a field programmable gate array emulation data structure, to obtain an emulation result. The field programmable gate array may be operating on the FPGA/emulation server 120, which may be a cloud server. Test results may be returned by the FPGA/emulation server 120 to the integrated circuit design service infrastructure 110 and relayed in a useful format to the user (e.g., via a web client or a scripting API client).

The integrated circuit design service infrastructure 110 may also facilitate the manufacture of integrated circuits using the integrated circuit design in a manufacturing facility associated with the manufacturer server 130. In an example, a physical design specification (e.g., a graphic data system (GDS) file, such as a GDSII file) based on a physical design data structure for the integrated circuit is transmitted to the manufacturer server 130 to invoke manufacturing of the integrated circuit (e.g., using manufacturing equipment of the associated manufacturer). For example, the manufacturer server 130 may host a foundry tape-out website that is configured to receive physical design specifications (e.g., such as a GDSII file or an open artwork system interchange standard (OASIS) file) to schedule or otherwise facilitate fabrication of integrated circuits. In an example, the integrated circuit design service infrastructure 110 supports multi-tenancy to allow multiple integrated circuit designs (e.g., from one or more users) to share fixed costs of manufacturing (e.g., reticle/mask generation, and/or shuttles wafer tests). For example, the integrated circuit design service infrastructure 110 may use a fixed package (e.g., a quasi-standardized packaging) that is defined to reduce fixed costs and facilitate sharing of reticle/mask, wafer test, and other fixed manufacturing costs. For example, the physical design specification may include one or more physical designs from one or more respective physical design data structures in order to facilitate multi-tenancy manufacturing.

In response to the transmission of the physical design specification, the manufacturer associated with the manufacturer server 130 may fabricate and/or test integrated circuits based on the integrated circuit design. For example, the associated manufacturer (e.g., a foundry) may perform optical proximity correction (OPC) and similar post-tape-out/pre-production processing, fabricate the integrated circuit(s) 132, update the integrated circuit design service infrastructure 110 (e.g., via communications with a controller or a web application server) periodically or asynchronously on the status of the manufacturing process, perform appropriate testing (e.g., wafer testing), and send to a packaging house for packaging. A packaging house may receive the finished wafers or dice from the manufacturer and test materials and update the integrated circuit design service infrastructure 110 on the status of the packaging and delivery process periodically or asynchronously. In an example, status updates may be relayed to the user when the user checks in using the web interface, and/or the controller might email the user that updates are available.

In an example, the resulting integrated circuit(s) 132 (e.g., physical chips) are delivered (e.g., via mail) to a silicon testing service provider associated with a silicon testing server 140. In an example, the resulting integrated circuit(s) 132 (e.g., physical chips) are installed in a system controlled by the silicon testing server 140 (e.g., a cloud server), making them quickly accessible to be run and tested remotely using network communications to control the operation of the integrated circuit(s) 132. For example, a login to the silicon testing server 140 controlling a manufactured integrated circuit(s) 132 may be sent to the integrated circuit design service infrastructure 110 and relayed to a user (e.g., via a web client). For example, the integrated circuit design service infrastructure 110 may be used to control testing of one or more integrated circuit(s) 132.

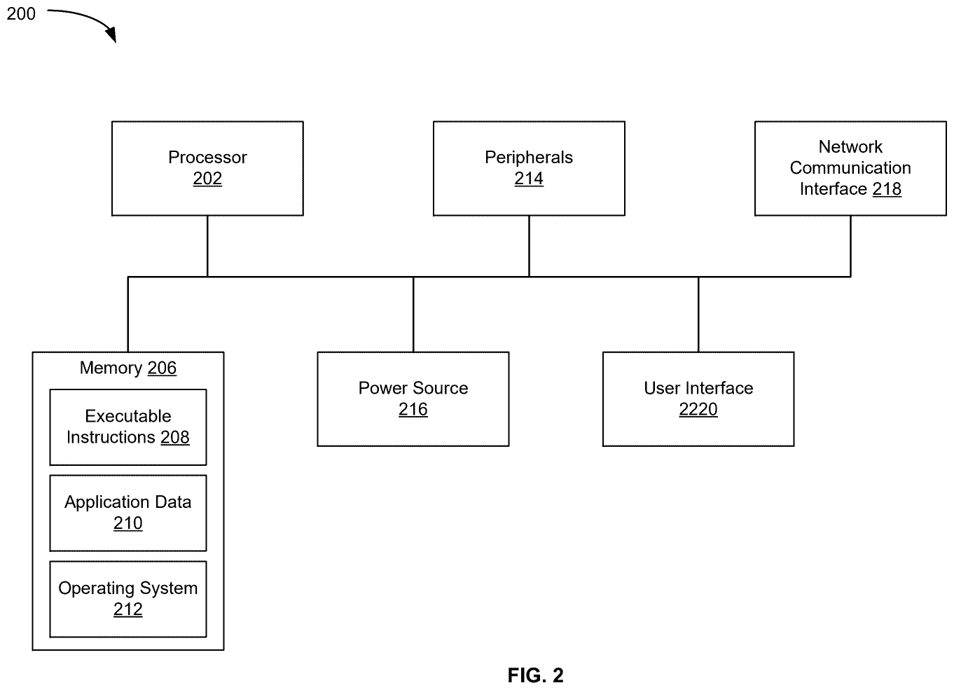

FIG. 2 illustrates an example of computing components of a system 200 for facilitating generation of integrated circuits in accordance with embodiments of the present disclosure. The system 200 can be a computing device or server (or a set of servers providing a cloud computing environment) that may be used to implement the integrated circuit design service infrastructure 110. The computing components can include a processor 202, a bus 204, a memory 206, peripherals 214, a power source 216, a network communication interface 218, a user interface 220, other suitable components, or a combination thereof.

The processor 202 can be a central processing unit (CPU), such as a microprocessor, and can include single or multiple processors having single or multiple processing cores. Alternatively, the processor 202 can include another type of device, or multiple devices, now existing or hereafter developed, capable of manipulating or processing information. For example, the processor 202 can include multiple processors interconnected in any manner, including hardwired or networked, including wirelessly networked. In an example, the operations of the processor 202 can be distributed across multiple physical devices or units that can be coupled directly or across a local area or other suitable type of network. In an example, the processor 202 can include a cache, or cache memory, for local storage of operating data or instructions.

The memory 206 can include volatile memory, non-volatile memory, or a combination thereof. For example, the memory 206 can include volatile memory, such as one or more dynamic random access memory (DRAM) modules such as double data rate (DDR) synchronous DRAM (SDRAM), and non-volatile memory, such as a disk drive, a solid-state drive, flash memory, Phase-Change Memory (PCM), or any form of non-volatile memory capable of persistent electronic information storage, such as in the absence of an active power supply. The memory 206 can include another type of device, or multiple devices, now existing or hereafter developed, capable of storing data or instructions for processing by the processor 202. The processor 202 can access or manipulate data in the memory 206 via the bus 204. Although shown as a single block in FIG. 2, the memory 206 can be implemented as multiple units. For example, a system 200 can include volatile memory, such as random access memory (RAM), and persistent memory, such as a hard drive or other storage.

The memory 206 can include executable instructions 208, data, such as application data 210, an operating system 212, or a combination thereof, for immediate access by the processor 202. The executable instructions 208 can include, for example, one or more application programs, which can be loaded or copied, in whole or in part, from non-volatile memory to volatile memory to be executed by the processor 202. The executable instructions 208 can be organized into programmable modules or algorithms, functional programs, codes, code segments, or combinations thereof to perform various functions described herein. For example, the executable instructions 208 can include instructions executable by the processor 202 to cause the system 200 to automatically, in response to a command, generate an integrated circuit design and associated test results based on a design parameters data structure. The application data 210 can include, for example, user files, database catalogs or dictionaries, configuration information or functional programs, such as a web browser, a web server, a database server, or a combination thereof. The operating system 212 can be, for example, Microsoft Windows®, macOS®, or Linux®; an operating system for a small device, such as a smartphone or tablet device; or an operating system for a large device, such as a mainframe computer. The memory 206 can comprise one or more devices and can utilize one or more types of storage, such as solid-state or magnetic storage.

The peripherals 214 can be coupled to the processor 202 via the bus 204. The peripherals 214 can be sensors or detectors, or devices containing any number of sensors or detectors, which can monitor the system 200 itself or the environment around the system 200. For example, a system 200 can contain a temperature sensor for measuring temperatures of components of the system 200, such as the processor 202. Other sensors or detectors can be used with the system 200, as can be contemplated. In an example, the power source 216 can be a battery, and the system 200 can operate independently of an external power distribution system. Any of the components of the system 200, such as the peripherals 214 or the power source 216, can communicate with the processor 202 via the bus 204.

The network communication interface 218 can also be coupled to the processor 202 via the bus 204. In an example, the network communication interface 218 can comprise one or more transceivers. The network communication interface 218 can, for example, provide a connection or link to a network, such as the network 106 shown in FIG. 1, via a network interface, which can be a wired network interface, such as Ethernet, or a wireless network interface. For example, the system 200 can communicate with other devices via the network communication interface 218 and the network interface using one or more network protocols, such as Ethernet, transmission control protocol (TCP), Internet protocol (IP), power line communication (PLC), Wi-Fi, infrared, general packet radio service (GPRS), global system for mobile communications (GSM), code division multiple access (CDMA), or other suitable protocols.

A user interface 220 can include a display; a positional input device, such as a mouse, touchpad, touchscreen, or the like; a keyboard; or other suitable human or machine interface devices. The user interface 220 can be coupled to the processor 202 via the bus 204. Other interface devices that permit a user to program or otherwise use the system 200 can be provided in addition to or as an alternative to a display. In an example, the user interface 220 can include a display, which can be a liquid crystal display (LCD), a cathode-ray tube (CRT), a light emitting diode (LED) display (e.g., an organic light emitting diode (OLED) display), or other suitable display. In an example, a client or server can omit the peripherals 214. The operations of the processor 202 can be distributed across multiple clients or servers, which can be coupled directly or across a local area or other suitable type of network. The memory 206 can be distributed across multiple clients or servers, such as network-based memory or memory in multiple clients or servers performing the operations of clients or servers. Although depicted here as a single bus, the bus 204 can be composed of multiple buses, which can be connected to one another through various bridges, controllers, or adapters.

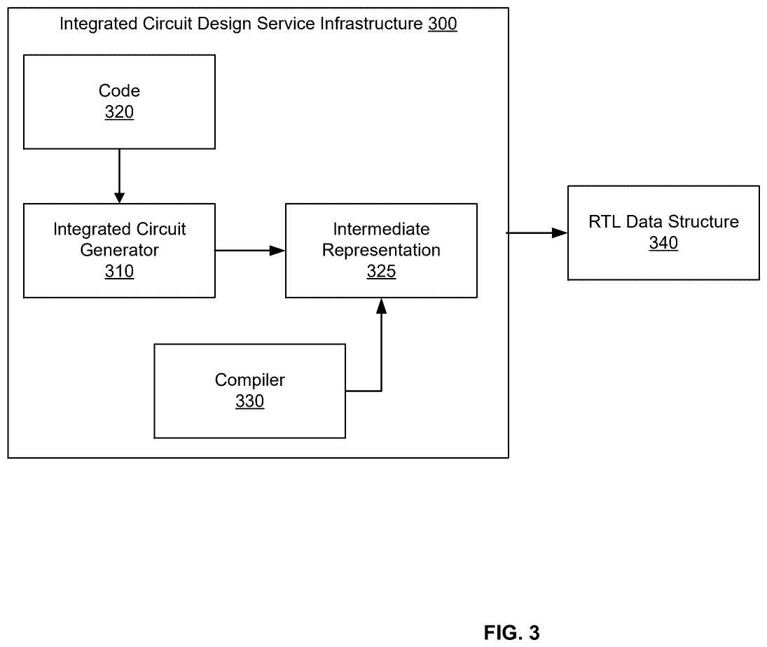

FIG. 3 illustrates an example of components of an integrated circuit design service infrastructure 300 in accordance with embodiments of the present disclosure. The integrated circuit design service infrastructure 300 is an example of the integrated circuit design service infrastructure 110 of FIG. 1. The components can include an integrated circuit generator 310 and a compiler 330 that may be implemented as part of the executable instructions 208 of FIG. 2.

In an example, the integrated circuit generator 310 uses an HDL, such as Chisel, embedded in a general-purpose programming language, such as Scala, that supports object-oriented programming and/or functional programming. Based on user input to the circuit design service infrastructure 300 (e.g., via an API or a web interface) defining a code 320, the integrated circuit generator 310 generates an intermediate representation 325 (e.g., a FIRRTL intermediate representation) for a circuit design. The user input can indicate different parameters for the circuit design including, for example, groupings of data (referred to as atomic data groups), an indication whether each grouping is to be protected, the protection type for each protected grouping, operations to be applied to the groupings, and the like. The code 320 can reflect the user input. The compiler 330 can check for errors, including structural and/or behavioral errors related to the protections. It is possible that the compiler 330 can be implemented as a component of the integrated circuit generator 310. Once compiled, an RTL data structure 340 can be generated defining the circuit design. Here, the circuit design can include protection components at the granularity level of the atomic data groups.

The code 320 may include instances of module descriptions that describe an integrated circuit. A module description may describe a functional operation of a module (e.g., operation of a processor core or a cache). The module descriptions can be manipulated using functions of a general-purpose programming language (e.g., embedded in Scala). Interfaces to the module descriptions can be encoded in types associated with the general-purpose programming language. The code 320 may further include variables, each corresponding to a grouping, a declaration for the variable, an indication in a declaration whether the variable is protected and, as applicable, a protection context, operations applied to the variables, and annotation(s), as applicable, indicating that a variable to which an operation is applied is protected.

An instance of a module description may be representative of hardware to be implemented in the integrated circuit. A module description can correspond to a state element, a processing component, and/or a protection component, among other integrated circuit modules. Additionally, one or more instances may be configured to be in communication with one or more other instances, such via an internal system bus.

An instance of a module description may include inputs and/or outputs that are internal to the integrated circuit design (e.g., internal inputs and/or outputs). An instance of a module description may also include inputs and/or outputs that are external to the integrated circuit design (e.g., system level inputs and/or outputs).

From the code 320, the integrated circuit generator 310 can generate the intermediate representation 325 that may be then compiled by the compiler 330 (e.g., execute the transformations) to generate the RTL data structure 340. As further described herein below, before doing so, the integrated circuit generator 310 can check the code 320 for structural and/or behavioral errors. Upon the code 320 being error free, the intermediate representation 325 can be generated. The RTL data structure 340 may encode logic descriptions associated with the instances of module descriptions implemented in the integrated circuit design. In an example, the compiler 330 may be a FIRRTL compiler that compiles the integrated circuit design to generate the RTL data structure 340. In an example, the RTL data structure 340 may comprise Verilog.

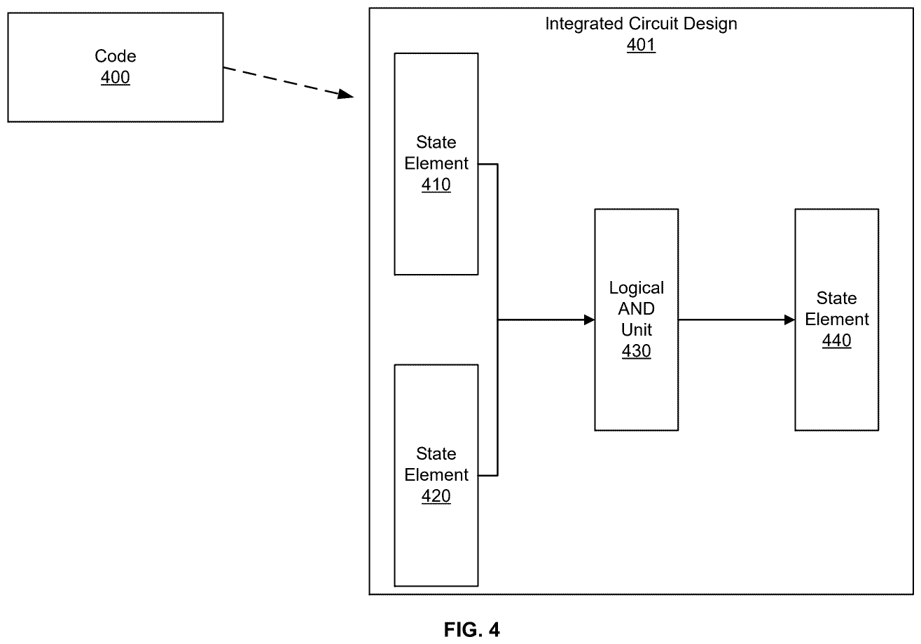

FIG. 4 illustrates an example of an integrated circuit design 401 that excludes protection in accordance with embodiments of the present disclosure. In the interest of clarity of explanation, a particular and simple circuit is illustrated. However, the embodiments of the present disclosure are not limited to this illustrative circuit. Instead, the embodiments similarly and equivalently apply to any circuit that may be designed via an integrated circuit design service infrastructure, such as the integrated circuit design service infrastructure 300 of FIG. 3.

Generally, code 400 (an example of the code 320) can be stored to describe the integrated circuit design 401. The description does not indicate that the integrated circuit design 401 includes protection. This code 400 can be used to generate an intermediate representation that can be then compiled to generate an RTL data structure defining the integrated circuit design 401. Because no protection is described, the integrated circuit design 401 excludes protection components that protect the integrated circuit from data errors.

As illustrated, the integrated circuit design 401 indicates that the integrated circuit includes the following components: a first state element 410 usable to store first input data, a second state element 420 usable to store second input data, a logical AND unit 430 usable to combine the first and second input data (e.g., corresponding to an “AND” operation) to generate output data, and a third state element 440 usable to store the output data. In an example, each state element 410, 420, and 440 can be a register implemented as a set of flip flops (each flip flop included multiple transistors). The logical AND unit 430 can be a set of AND gates. The integrated circuit design 401 can also indicate that data lines (e.g., wires, wire traces, etc.) connect the state elements 410 and 420 (e.g., the outputs of the flip flops) to the inputs of the logical AND unit 430, and data lines connect the outputs of the logical AND unit 430 to the inputs of the state element 440.

The code 400 can include a first variable corresponding to the first input data, a second variable correspond to the second output data, and a third variable corresponding to the output data. Each of these variables can have a declaration about its type. The code 400 can also include syntax for an AND operation applied to the variables.

An example of the code 400 from which the integrated circuit design 401 is generated can be expressed in Chisel as:
class Example extends Module {
   val x=Reg (Payload)//corresponds to the first input data
   val y=Reg (Payload)//corresponds to the second input data
   val z=Reg (Payload)//corresponds to the output data
   }
   z.data: =x.data & y.data//corresponds to the AND operation
}

The designed integrated circuit lacks protection. Assume that when in use, the first state element 410 stores data. Due to an event, such as a gamma ray burst, a power interruption, and/or an electrical disturbance, at least a portion of the data becomes erroneous (e.g., a binary value of a bit flips from a “0” to a “1” or vice versa in a memory cell of the register). Because no protection is implemented, the error cannot be detected. Depending on the use of the circuit, particular performance requirements can apply. These requirements may not tolerate the data errors (or a certain rate thereof). Accordingly, the integrated circuit may not be robust enough or may become inoperable.

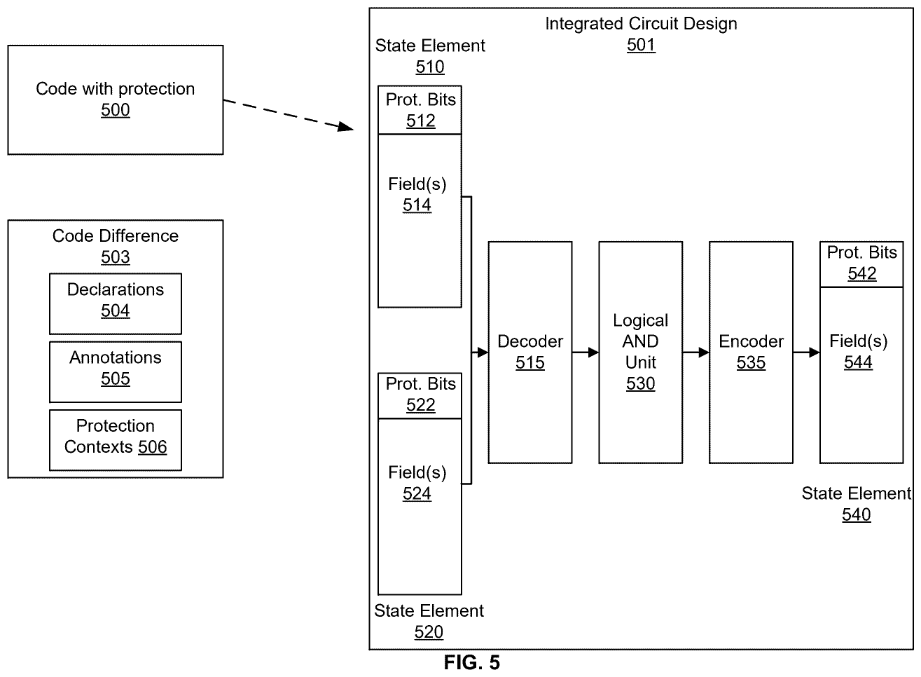

FIG. 5 illustrates an example of an integrated circuit design 501 that includes protection in accordance with embodiments of the present disclosure. In the interest of clarity of explanation, a particular and simple circuit is illustrated and corresponds to the circuit of FIG. 4, except that protection is added thereto. However, the embodiments of the present disclosure are not limited to this illustrative circuit. Instead, the embodiments similarly and equivalently apply to any circuit that may be designed via an integrated circuit design service infrastructure, such as the integrated circuit design service infrastructure 300 of FIG. 3.

Generally, code 500 (an example of the code 320) can be stored to describe the integrated circuit design 501. The description indicates that the integrated circuit design 501 should include protection. This indication can be generated based on user input requesting that a particular grouping of data be protected. In the illustration of FIG. 5, the grouping corresponds to data in two data fields, each included in a different state element. This code 500 can be used to generate an intermediate representation that can be then compiled to generate an RTL data structure defining the integrated circuit design 501. Because protection is described, the integrated circuit design 501 includes protection components that protect the integrated circuit from data errors.

As illustrated, the integrated circuit design 501 indicates that the integrated circuit includes the following components: a first state element 510 that includes one or more fields 514 usable to store first input data, a second state element 520 that includes one or more fields 524 usable to store second input data, a logical AND unit 530 usable to combine the first and second input data (e.g., corresponding to an “AND” operation) to generate output data, and a third state element 540 that includes one or more fields 544 usable to store the output data. For the protection, the integrated circuit design 501 indicates two protection components: a decoder 515 and an encoder 535. Additionally, protection bits 512 are to be stored in the first state element 510 to protect the first input data, protection bits 522 are to be stored in the second state element 522 to protect the second input data, and protection bits 542 are to be stored in the third state element 540 to protect the output data. In an example, the decoder 515 is configured to decode the first input data (and the protection bits 512) and the second input data (and the protection bits 522) depending on the type of protection applied to the first input data and the second input data. For example, the decoder 515 can be a SECDED decoder and/or parity bits-based decoder. Conversely, the encoder 535 can be configured to the encode the outputs of the logical AND unit 530 (e.g., to generate the protection bits 542) depending on the type of protection applied to the first input data and the second input data or applied to the output data. For example, the encoder 535 can be a SECDED encoder and/or parity bits-based encoder. The integrated circuit design 501 can also indicate that data lines (e.g., wires, wire traces, etc.) connect the state elements 510 and 520 (e.g., the outputs of the flip flops) to the inputs of the decoder 515, data lines connect the outputs of the decoder 515 to the inputs of the logical AND unit 530, data lines connect the outputs of the logical AND unit 530 to the inputs of the encoder 535, and data lines connect the outputs of the encoder 535 to the inputs of the state element 540.

Relative to the user input of FIG. 4, here the user input additionally indicates the following protection parameters. A first protection parameter can indicate the grouping of data to be protected as an atomic data group. This grouping can span a part of a field or multiple fields within a state element and/or can be across multiple state elements. In the illustration of FIG. 5, the grouping spans the entirety of the first input data and the second input data in the two state elements 510 and 520. A second protection parameter can indicate that the grouping is to be protected. For example, in the code 500, a variable corresponding to the grouping can be defined and can be declared to have a protected type. A third protection parameter can indicate the type(s) of protection(s) to be applied to the grouping. Data belonging to different fields and/or state elements can be protected differently. For example, referring to the illustration of FIG. 5, one type of protection (e.g., SECDED) can be applied to the first input data of the first state element 510, whereas the same or a different type of protection (e.g., error correction codes) can be applied to the second input data of the second state element 520. Similarly, the same or a different type of protection can be applied to protect the output data (e.g., whereas both the first and second input data is protected with parity error detection codes, the output data can be protected with error correction codes). In an example, the third protection parameter can be defined as a protection context in the code 500. A fourth protection parameter can indicate that, if error detection is only applied (no error correction is to be implemented), a destination of or a subscriber to an error event indicating that a data error was detected. This fourth parameter can also be included in the code 500. Such parameters can be defined in a library usable by the HDL (e.g., Chisel).

The code 500 can include a variable corresponding to data in one or more fields of a state element. Referring to FIG. 5, the code 500 can include a first input variable corresponding to the first input data, a second input variable corresponding to the second input data, and an output variable corresponding to the output data. The code 500 can also include a declaration for each variable. The declaration of a variable can indicate its type and data fields (e.g., the entire data in the first variable is payload data), and whether any protection is applied thereto. Recall that a variable can correspond to data belonging to an atomic data group that is to be protected. In this case, the declaration of the variable indicates that this variable is protected. Further, the code 500 can include an operation (e.g., a syntax for the logic of the operation) that applies to a set of variables. In the illustration of FIG. 5, the code 500 includes an AND operation applied to the first and second input variables. In this case, depending on the protection type of a variable to which the operation applies, the code includes an annotation for the variable in the syntax of the operation. The annotation is included to indicate that the variable is protected.

An example of the code 500 from which the integrated circuit design 501 is generated can be expressed in Chisel as:
class Example extends Module {
   val EC=ErrorContext//corresponds to the protection that is to be applied
   val x=ProtectedReg (Payload)//corresponds to the first input data to be protected
   val y=ProtectedReg (Payload)//corresponds to the second input data to be protected
   val z=ProtectedReg (Payload)//corresponds to the output data to be protected
   }
   z.data: =x.data.q & y.data.q//corresponds to the AND operation, where “q” indicates the decoding of protected data
}

The designed integrated circuit includes protection. Assume that when in use, the first state element 510 stores data. Due to an event, such as a gamma ray burst, a power interruption, and/or an electrical disturbance, at least a portion of the data becomes erroneous (e.g., a binary value of a bit flips from a “0” to a “1” in a memory cell of the register). Because protection is implemented, the error can be detected (particularly by the decoder 515 and can be corrected by this decoder 515 or by some other component). Depending on the use of the circuit, particular performance requirements can apply. These requirements may not tolerate the data errors (or a certain rate thereof). Accordingly, the integrated circuit may be robust enough and may remain operable.

When the code 500 is compared to the code 400, a code difference 503 between the two may be minimal. In particular, the code difference 503 includes declarations 504 of whether protection(s) is (are) applied, annotations 505 in the syntax(es) of the operation(s) (e.g., the “q” annotations), and protection contexts 506 (e.g., indicating the type(s) of protection to be used). The data structure may not change. The minimal code difference 503 can provide several technological advantages. For example, assume that the code 400 was previously written and validated for a complex circuit for which no protection was initially designed. This code 400 (and/or corresponding circuit design) may have been subject to an intense review and validation process before being released for use (e.g., through a reliability, availability, and serviceability (RAS) process, or a functional safety (FUSA) process). Assume that after this process is completed, the protection is now desired and is to be designed. This protection can be for all, many, or a few groupings of data, or even a single grouping of data. Rather than having to re-write the entire code 400 or relevant portions thereof, the minimal code difference 503 can be introduced, whereby the relevant declarations 505, annotations 504, and protection contexts 506 are added. In this case, the review and validation process is fairly also minimal because it may be sufficient to review and validate the code difference 503 rather than the entire code 500. Conversely, assume that the protection is no longer desired for one or more of the groupings of data. In this case, the relevant declarations 504, annotations 505, and protection contexts 506 can be removed from the code 500. Alternatively, the relevant protection contexts 506 can be updated to indicate that the protection type(s) are set to none (e.g., to “identity” or some other predefined type for which no actual protection is applied).

In the illustration of FIG. 5, the atomic data group corresponds to the first input data and the second input data. Other groupings are possible. For example, assume that only the first five bits of the first input data and the last eight bits of the second input data form an atomic group. In this case, a variable can be defined and can correspond to the atomic group data. This variable can be referred to as a bundle. The data protection is applied to the bundle.

In the above example, a position of an annotation relative to a variable can indicate how protection is to be applied. For instance, “.q” is used to indicate that decoding is to be applied to the corresponding chunk of data. To illustrate and referring back to the above example of FIG. 5, “x.q.data” indicates that all of “x” is to be decoded. In comparison, “x.data.q” indicates the decoding of just “x.data.”

According to embodiments of the present disclosure, the first state element 510 is configured to store data that belongs to an atomic data group. The integrated circuit design 501 indicates that the first state element 510 is to store protection data (e.g., the protection bits 512) to be used by a protection component (e.g., the decoder 515) to determine whether an error exists in the data. The protection data (e.g., the size and binary values of the protection bits) can depend on the type of protection indicated in the relevant protection context 506. The integrated circuit design 501 also indicates that the second state element 520 is to store a different portion of the data that belongs to the atomic data group. The integrated circuit design 501 further indicates that the protection component (e.g., the decoder 515) is connected to the first state element 510 and the second state element 520. In other words, the granularity of the data protection is at the atomic data group level, where the protection element is implemented specifically for the state element(s) storing the atomic data group.

As indicated above, multiple groupings can be defined. If so, the same or different types of protection can be defined in the code 500, each type corresponding to one of the groupings. For instance, assume that the first input data and the second input data form a first grouping. One type of protection (or possible multiple types as described above) can be defined to protect this first grouping. Assume that the output data and some other data form a second grouping. Another type of protection (or possible multiple types as described above) can be defined to protect this second group. In this illustration, the decoder 515 can implement decoding techniques according to the protection type(s) applied to the first grouping. In comparison, a second decoder (not shown) is indicated in the circuit design for the second grouping. Because the protection is at the atomic data group level, the second decoder is separate from the decoder 515 and can implement decoding techniques according to the protection type(s) applied to the second grouping.

Referring back to the illustration of FIG. 5, the first input data and the second input data form a grouping to which an operation is to be applied by the logical AND unit 530. A protection component of the integrated circuit design 501 includes the decoder 515 connected to the state elements 510 and 530 and configured to decode only the data of the grouping. In other words, the decoder 515 is implemented at the atomic data group level by being specific to the grouping, rather than being operational on additional data beyond the grouping. Note that the each of the state elements 510 and 520 is further configured to store additional data (e.g., the protection bits 512 and 522) associated with decoding the data of the grouping. The decoder 515 operates on the first and second input data and the protection bits 512 and 522 (e.g., receives them as input).

Furthermore, a protection component of the integrated circuit design 501 includes the encoder 535 connected to the state element 540. This encoder 535 is configured to encode only the data of the grouping. In other words, the encoder is also implemented at the atomic data group level by being specific to the grouping, rather than being operational on additional data beyond the grouping. Here also, the state element 540 is further configured to store additional data (e.g., the protection bits 542) associated with encoding the data of the grouping. The protection buts 542 can be output by the encoder 535.

In an example, the declaration and the annotation included in the code 500 for a variable indicates, without a change to a data structure and/or to a logic of an operation, that the grouping is subject to data protection in hardware. Referring back to the two input variables, each is declared as being protected and, an annotation “q” is included in the syntax of the logic for each of these variables. The declarations and the annotations do not change the underlying data structure of the first input data and the second input data or any other data that the integrated circuit stores and/or processes. Further, the declarations and the annotations do not change the logic of the AND operation (e.g., this operation is still an AND, whereas the annotations “q” are added to the syntax of this logic in the code 500).

The code 500 itself does not define a structure for any of the protection components. In comparison, the circuit design is generated to indicate the structure(s) of the protection component(s) upon a determination that an operation applies to a grouping of data that is to be protected. This determination can be based on a relevant variable is declared as protected, the operation changes the variable, and the variable is input to or output of the operation. Referring back to the encoder 515, the integrated circuit design service infrastructure can determine that the two input variables are protected, a logic for an AND operation uses these two variables and generates a change to the underlying first and second input data by combining them. Accordingly, even though the code 500 does not explicitly define an encoder or a function of an encoder, the integrated circuit design service infrastructure automatically adds the encoder 515 to the integrated circuit design 501, where the integrated circuit design 501 indicates a configuration of the encoder 515. The configuration corresponds to the relevant protection context 506.

Defining protection at an atomic data group level can be useful in many contexts. For example, when a tile of data is processed in multiple cycles or its processing is distributed among multiple processing components (e.g., as in core pipeline), the use of protection described in FIG. 5 can result in power savings. Particularly, the resulting circuit design would implement protection components, each of which corresponding to an atomic data group. A protection component would be only used when data of the corresponding atomic data group is being processed, avoiding the need to process the entire tile. To illustrate, consider an example of a reduced instruction set computer (RISC) processor, such as a 32-bit RISC processor. An instruction can include hundreds of bits that inform different processing components of the RISC processor about processing to be applied. These bits can be spatially and/or temporally distributed. Rather that implementing an encoder and/or decoder that would encode and decode the entire set of bits repeatedly, the bits can be organized in groupings and each grouping can be associated with a corresponding encoder/decoder. Here, the relevant encoder/decoder can be used depending on the processing cycle and/or processing component.

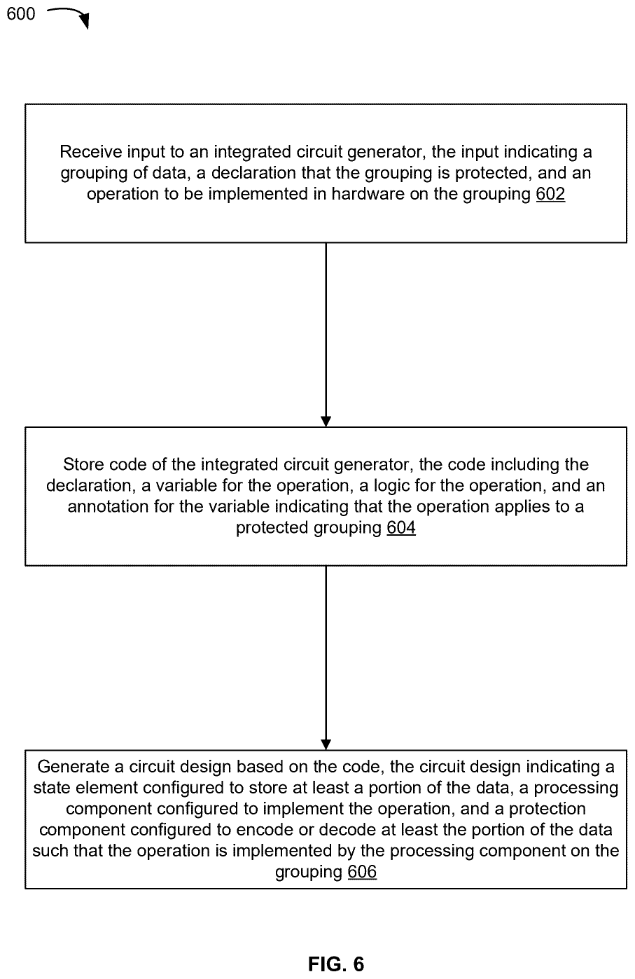

FIGS. 6-8 illustrate flow examples related protecting an integrated circuit design. Operations of the flows can be implemented by a system that implements components of an integrated circuit design service infrastructure, such as the system 200 of FIG. 2. In some examples, the operations may be implemented by executing instructions stored in a tangible, non-transitory, computer-readable storage medium, such as a memory of the system. While the flows are described in a specific sequence, it should be understood that the present disclosure contemplates that the operations may be performed in different sequences than the sequence illustrated, and certain described operations may be omitted or not performed altogether.

FIG. 6 illustrates an example of a flow 600 for generating an integrated circuit design including protection in accordance with embodiments of the present disclosure. The flow 600 may include operation 602, where the system receives input to an integrated circuit generator. The input indicates a grouping of data, a declaration that the grouping is protected, and an operation to be implemented in hardware on the grouping. The input can be received via an API or web interface and can describe other aspects (e.g., functional aspects) of an integrated circuit to be designed. The integrated circuit generator can use an HDL and the input can correspond to HDL code input.

In an example, the flow 600 includes operation 604, where the system stores code of the integrated circuit generator. The code includes the declaration, a variable for the operation, a logic for the operation, and an annotation for the variable indicating that the operation applies to a protected grouping. For example, the code can be generated in the HDL by the integrated circuit generator based on the input and can have a similar code structure and properties as the code 500 of FIG. 5.

In an example, the flow 600 includes operation 606, where the system generates a circuit design based on the code. The circuit design indicates a state element configured to store at least a portion of the data, a processing component configured to implement the operation, and a protection component configured to encode or decode at least the portion of the data such that the operation is implemented by the processing component on the grouping. The integrated circuitry generator can check the code for errors. Based on the code being error free, the integrated circuit generator can output an IR data structure. A compiler of the integrated circuit design service infrastructure can compile the IR data structure to generate another data structure (e.g., an RTL data structure) capturing the circuit design.

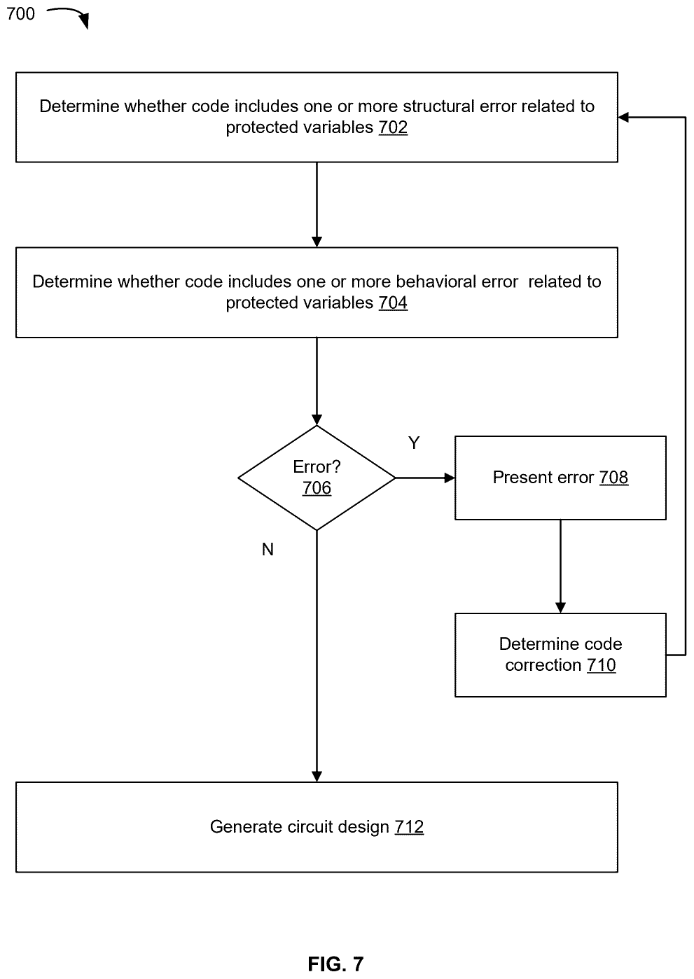

FIG. 7 illustrates an example of a flow 700 for correcting protection errors in an integrated circuit design in accordance with embodiments of the present disclosure. The flow 700 may include operation 702, where the system determines whether code (e.g., corresponding to the one of FIG. 6) includes one or more structural errors related to protected variables. A structural error can be determined based on a declaration and an annotation of a variable. Particularly, a variable can be declared to be protected or unprotected. Syntax for a logic of an operation that uses the variable as input or output may include an annotation of the variable being protected. As such, a structural error exists when either the declaration is for a protected variable and no annotation indicating this protection is included in the logic, or the declaration is for an unprotected variable and an annotation indicating data protection is included in the logic. By cross-checking the declaration against the annotation (or lack thereof), the integrated circuitry generator can determine whether the structural error exists.

In an example, the flow 700 includes operation 704, where the system determines whether the code includes one or more protected errors related to protected variables. A behavioral error can be determined based on data being grouped together as belonging to a protected grouping and an operation applied to the grouping. Particularly, the data forms an atomic data group. As such, the operation is expected to be applied to the atomic data group as a whole. If the operation deviates from such an application, a behavioral error can exist. As such, the integrated circuitry generator can determine the input and/or variables of the operation. As far as the input variables, if they are missing a variable that take values for some of the atomic data group, a behavioral error can be found. For instance, referring to the integrated circuit design 501 of FIG. 5, the AND operation applies to two input variables taking the values of the first input data and the second input data, respectively. The first input data and the second input data form an atomic data group. As such, if the AND operation uses only one of the two input variables, the behavioral error can be found. As far as an output variable, the operation can change an input variable(s) to generate the output variable. In this case, the input variable(s) and the output variable may need to have the same type of declarations: either protected or unprotected. By cross-checking the input variable declarations against the output variable declaration for the protection types, the integrated circuitry generator can determine whether a behavioral error exists. For instance, if the input variables are protected but a corresponding output variable is unprotected, a behavioral error may be found. Similarly, if the input variables are unprotected but a corresponding output variable is protected, a behavioral error may be found.

In an example, the flow 700 includes operation 706, where the system determines whether any error is found (structural or behavioral). If so, operation 708 follows operation 706. Otherwise, operation 712 follows operation 706.

In an example, the flow 700 includes operation 708, where the system presents the error. For instance, a structural error can be presented using one type of presentation format (e.g., a font color), whereas behavioral error can be presented using a different type of presentation format (e.g., a different font color). Each error can be presented at a user interface.

In an example, the flow 700 includes operation 710, where the system determines a code correction to mitigate the error(s). For instance, additional input can be received to update the code, where the input corrects the code structure and/or behavior. Additionally, or alternatively, the system can implement or call over an interface an artificial intelligence model trained for code correction. The call can include the code, or snippets thereof, with a description of the error(s). The artificial intelligence model can output the update to the code. The flow 700 can loop back to operation 702 to recheck for errors or can proceed to operation 712 under the assumption that the code is error free.

In an example, the flow 700 includes operation 712, where the system generates the circuit design based on the code being error free. Upon the code being error-free, the integrated circuitry generator can generate an IR data structure, and the compiler can compile this IR data structure into an RTL data structure capturing the circuit design.

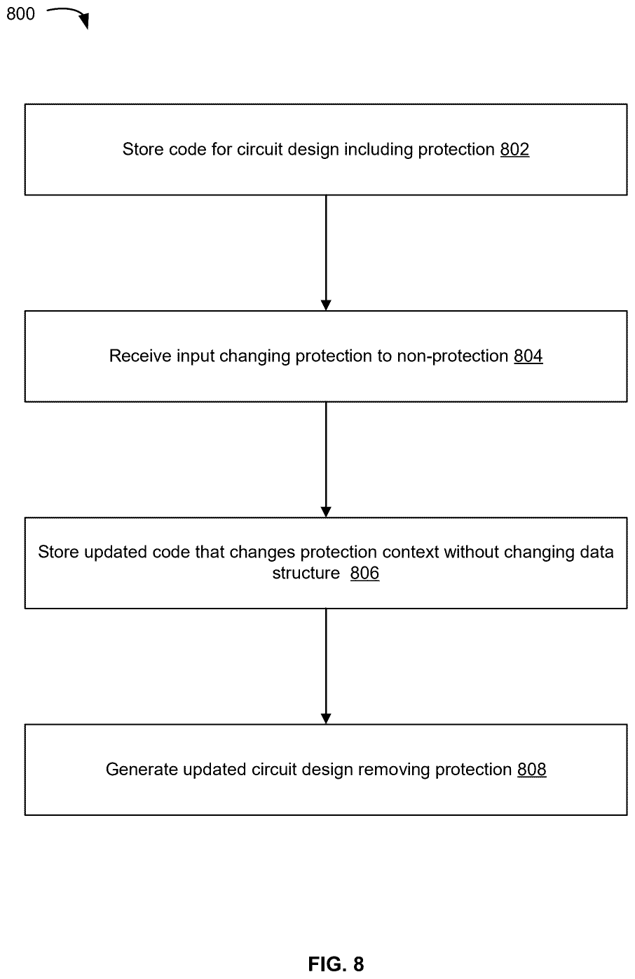

FIG. 8 illustrates an example of a flow 800 for updating an integrated circuit design including protection in accordance with embodiments of the present disclosure. The flow 800 may include operation 802, where the system stores code for a circuit design including data protection. The code can be written in an HDL, have a similar code structure and properties as the code 500 of FIG. 5, and be stored in a memory of the system.

In an example, the flow 800 includes operation 804, where the system receives input changing protection to non-protection. For instance, in the existing version of the code, data can belong to an atomic data group and this group can have a corresponding variable(s). The variable(s) can be declared as protected in the existing version. The input can be received via an API or a web interface and can indicate that the data need not be protected anymore. For instance, the input can request a change to the protection context from a particular type of data protection (e.g., SECDED or error correction codes) to none (or “identity”).

In an example, the flow 800 includes operation 806, where the system stores updated code that changes the protection context without changing the data structure. For instance, only the protection context is changed to indicate that the protection type is none (or “identity”). No other changes to the existing version of the code may be needed (e.g., no annotations need to be removed or any syntax of an operation to be edited). The updated code can be stored as new version.

In an example, the flow 800 includes operation 808, where the system generates an updated circuit design removing protection. Here, the latest version of the code can be checked for errors, to then generate an IR data structure, and compile the IR data structure into an RTL data structure capturing the updated circuit design. In this design, the protection component (e.g., encoder and/or decoder) previously applicable to the variable(s) is removed.

Although the embodiments above have been described in considerable detail, numerous variations and modifications will become apparent to those skilled in the art once the above disclosure is fully appreciated. It is intended that the following claims be interpreted to embrace all such variations and modifications.

The specification and drawings are to be regarded in an illustrative rather than a restrictive sense. Various modifications and changes may be made without departing from the spirit and scope of the disclosure as set forth in the claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

What is claimed is:

1. A method comprising:
receiving input to an integrated circuit generator, the input indicating a grouping of data, a declaration that the grouping is protected, and an operation to be implemented in hardware on the grouping;
storing code of the integrated circuit generator, the code including the declaration, a variable for the operation, a logic for the operation, and an annotation for the variable indicating that the operation applies to a protected grouping; and
generating a circuit design based on the code, the circuit design indicating a state element configured to store at least a portion of the data, a processing component configured to implement the operation, and a protection component configured to encode or decode at least the portion of the data such that the operation is implemented by the processing component on the grouping.

2. The method of claim 1, wherein the state element is configured to store the data that belongs to the grouping, and wherein the circuit design indicates that the state element is to store protection data to be used by the protection component to determine whether an error exists in the data.

3. The method of claim 1, wherein the state element is a first state element that is configured to store the portion of the data that belongs to the grouping, and wherein the circuit design indicates that a second state element is to store a different portion of the data that belongs to the grouping, and wherein the circuit design further indicates that the protection component is connected to the first state element and the second state element.

4. The method of claim 3, wherein the code includes a bundle to which the declaration applies, wherein the bundle includes a first variable corresponding to the portion of the data and a second variable corresponding to the different portion of the data.

5. The method of claim 1, wherein the grouping is a first grouping, wherein the input further indicates a first type of protection for the first grouping, a second grouping of different data, and a second type of protection for the second grouping.

6. The method of claim 5, wherein the protection component is a first protection component, wherein the circuit design further indicates a second protection component, wherein the first protection component is configured based on the first type of protection, and wherein the second protection component is configured based on the second type of protection.

7. The method of claim 1, wherein the circuit design indicates that the state element includes a field configured to store the portion of the data and additional data, and wherein a position of the annotation relative to the variable indicates whether data protection is applied to the field or to only the portion of the data.

8. The method of claim 1, further comprising:
receiving additional input indicating that the grouping is to no longer be protected;
generating an update to the code, the update limited to only changing a type of data protection applied to the grouping; and
generating an updated circuit design based on the update, the updated circuit design indicating that the protection component is removed.

9. The method of claim 1, wherein the protection component includes an encoder connected to the state element and configured to encode only the data of the grouping.

10. The method of claim 9, wherein the state element is further configured to store additional data associated with encoding the data of the grouping.

11. The method of claim 1, wherein the protection component includes a decoder connected to the state element and configured to decode only the data of the grouping.

12. The method of claim 11, wherein the state element is further configured to store additional data associated with decoding the data of the grouping.

13. A system comprising:
one or more processors; and
one or more memories storing instructions that, upon execution by the one or more processors, configure the system to:
receive input to an integrated circuit generator, the input indicating a grouping of data, a declaration that the grouping is protected, and an operation to be implemented in hardware on the grouping;
store code of the integrated circuit generator, the code including the declaration, a variable for the operation, a logic for the operation, and an annotation for the variable indicating that the operation applies to a protected grouping; and
generate a circuit design based on the code, the circuit design indicating a state element configured to store at least a portion of the data, a processing component configured to implement the operation, and a protection component configured to encode or decode at least the portion of the data such that the operation is implemented by the processing component on the grouping.

14. The system of claim 13, wherein the execution of the instructions further configures the system to:
determine whether the code is error-free based on the declaration that the grouping is protected and the code including the annotation, wherein the circuit design is generated based on the code being error-free.

15. The system of claim 13, wherein the execution of the instructions further configures the system to:
determine whether the code is error-free based on the declaration that the grouping is protected and the operation being applied to the grouping, wherein the circuit design is generated based on the code being error-free.

16. One or more non-transitory computer-readable storage media storing instructions that, upon execution by one or more processors, cause operations comprising:
receiving input to an integrated circuit generator, the input indicating a grouping of data, a declaration that the grouping is protected, and an operation to be implemented in hardware on the grouping;
storing code of the integrated circuit generator, the code including the declaration, a variable for the operation, a logic for the operation, and an annotation for the variable indicating that the operation applies to a protected grouping; and
generating a circuit design based on the code, the circuit design indicating a state element configured to store at least a portion of the data, a processing component configured to implement the operation, and a protection component configured to encode or decode at least the portion of the data such that the operation is implemented by the processing component on the grouping.

17. The one or more non-transitory computer-readable storage media of claim 16, wherein the declaration and the annotation in the code indicates, without a change to a data structure of the data, that the grouping is subject to data protection in hardware.

18. The one or more non-transitory computer-readable storage media of claim 16, wherein the declaration and the annotation in the code indicates, without a change to the logic of the operation, that the grouping is subject to data protection in hardware.

19. The one or more non-transitory computer-readable storage media of claim 16, wherein the code does not define a structure for the protection component, and wherein the circuit design is generated to indicate the structure of the protection component upon a determination that the operation applies to the grouping.

20. The one or more non-transitory computer-readable storage media of claim 19, wherein the determination that the operation applies to the grouping includes a determination that the variable is declared as protected, the operation changes the variable, and the variable is input to or output of the operation.
